(19) United States
(12) Patent Application Publication
(10) Pub. No.: US 2015/0180343 A1
(43) Pub. Date: Jun. 25, 2015

(54) Control of a synchronous rectifier

(71) Applicants: Oscar Persson, Kalmar (SE); Xuefeng Yang, Shanghai (CN); Magnus Karlsson, Oskarshamn (SE)

(72) Inventors: Oscar Persson, Kalmar (SE); Xuefeng Yang, Shanghai (CN); Magnus Karlsson, Oskarshamn (SE)

(73) Assignee: Telefonaktiebolaget L M Ericsson (publ)

(21) Appl. No.: 14/414,861

(22) PCT Filed: Jul. 27, 2012
(86) PCT No.: PCT/SE2012/050855

§ 371 Date: Jan. 14, 2015

(51) Int. Cl. H02M 3/158

(52) U.S. Cl. CPC H02M 3/1588

(57) ABSTRACT

A method and a control unit for changing a working mode of a synchronous rectifier. The synchronous rectifier comprises at least one controllable switch having a diode in parallell thereof. The synchronous rectifier is operatively connected to a reactive circuit, and is arranged to receive at least one control signal at a control terminal, for controlling at least one controllable switch. The at least one control signal is pulse-width modulated with a defined duty-cycle. The method comprises adjusting the pulse-width of the at least one control signal between zero percent duty-cycle and the defined duty-cycle at a frequency above a cut-off frequency of the reactive circuit. Thereby, reducing the effect of a forward voltage drop over said diode in the synchronous rectifier.

### TECHNICAL FIELD

The present invention generally relates to the field of controlling a synchronous rectifier and more specifically to a method for changing a working mode of a synchronous rectifier and a device therefor.

### BACKGROUND

Switch mode power supplies, SMPS, are today the dominating technology for converting power in electronics. SMPS can be of different types, such as buck-, boost- and flyback-converters. A basic version of these different types of SMPS comprises at least one diode. The diode exhibits a forward voltage drop of approximately half a volt, and in an SMPS converter converting voltages in the order of a few volt such a voltage drop can be a substantial part of the total output voltage of the SMPS. Therefore, the loss in connection with the forward voltage drop of the at least one diode must be minimized in order to reduce power consumption and heat generation.

Conventionally, in order to counteract such a voltage drop associated with the forward voltage drop, the at least one rectifying diode of the SMPS may be replaced by a controllable switch such as a field effect transistor, FET. The SMPS also needs a control unit for handling the switching of the controlled switches. Such a controlled switch and control unit is typically called a synchronous rectifier, SR.

The most common controllable switch of an SR is a metal oxide semiconductor transistor, MOSFET, due to its excellent switching characteristics and low losses.

However, a MOSFET exhibits a parasitic diode between the body and the drain of the MOSFET due to the doped junctions therebetween. Hence, in connection with this parasitic diode a forward voltage drop exists. This parasitic diode can be used for operating an SR in a diode-mode of operation i.e. use the rectifying properties of the parasitic diode similar to a rectifying diode in a rectified SMPS. Thus, a SMPS with an SR utilizing at least one MOSFET as a controlled switch can be operated as a regular SMPS with rectifying diodes by exploiting the parasitic diodes.

Thus, an SR with MOSFETs can be operated in two different working modes wherein the first working mode is the synchronous-mode using the MOSFETs as controlled switches controlled by the control unit. The second working mode is the diode-mode utilizing the parasitic diodes of the MOSFET.

However, some problems exist with the use of an SR. The first problem is how to handle the precise timing of the switching of the controllable switches of the SR. Conventionally, this is either handled by an analogue circuit or by some kind of computerized control circuit. Another problem is that by its nature an SR could reverse the power if the output of the SMPS is pre-biased with a voltage. The problem associated with the reverse power is of great importance if several SMPS are connected in parallell for supplying a load with power. In the art it exists several solutions for handling the reverse power, such as e.g. a synchronous start and stop of the SMPS. But this solution does not handle the situation when one SMPS fails and becomes inoperative and later becomes operational again. In this situation it is undesirable to synchronously stop and start the other SMPS in the parallell configuration in order to enable the now functional SMPS to deliver power to the load.

A known method in the art to obviate the problems associated with reverse power is to start an SMPS with an SR in the diode-mode of operation and then change the working mode to the synchronous-mode of operation. However, this change of operation between diode-mode and synchronous-mode introduces a voltage step, corresponding to the forward voltage drop of the parasitic diodes of the MOSFET, in the output voltage of the SMPS. Such a voltage step could introduce other problems, e.g. related to overvoltage protection and voltage regulation. Especially, for a load with requirements of a low voltage and a high current, for example a modern CPU, the forward voltage drop over the parasitic diode could correspond to 40% of the output voltage from the SMPS.

### SUMMARY

It is an object of exemplary embodiments of the invention to address at least some of the issues outlined above. This object and others are achieved by the method and the device according to the appended independent claims, and by the embodiments according to the dependent claims

A first exemplary embodiment provides a method for changing a working mode of the synchronous rectifier. The synchronous rectifier comprises at least one controllable switch having a diode in parallell thereof. The synchronous rectifier is operatively connected to a reactive circuit, and is arranged to receive at least one control signal at a control terminal, for controlling said at least one controllable switch. The at least one control signal is pulse-width modulated with a defined duty-cycle. The method comprises adjusting the pulse-width of the at least one control signal between zero percent duty-cycle and the defined duty-cycle at a frequency above a cut-off frequency of the reactive circuit. Thereby, the effect of a forward voltage drop over said diode in the synchronous rectifier is reduced.

A second exemplary embodiment provides a control unit for changing a working mode of a synchronous rectifier. The synchronous rectifier comprises at least one controllable switch having a diode in parallell thereof. The at least one controllable switch is controlled by at least one control signal received at a control terminal. The synchronous rectifier is operatively connected to a reactive circuit. The control unit comprises at least one input terminal for receiving an input signal. The input signal is pulse-width modulated with a defined duty-cycle, for controlling the at least one controllable switch of the synchronous rectifier. The control unit further comprises an enable terminal for receiving an enable signal, and at least one output terminal operatively connected to said control terminal. The control unit is configured to adjust the pulse-width of the received at least one input signal at the at least one input terminal, between zero percent duty-cycle and the defined duty-cycle of the input signal at a frequency above a cut-off frequency of the reactive circuit, in response to the enable signal. Thereby, said output signal at the output terminal is formed, and the effect of a forward voltage drop over said diodes in the synchronous rectifier is reduced.

An advantage of exemplary embodiments is that the transition from a working mode to another is performed without an output voltage step at the output of the SMPS, and thereby obviating the problems associated with step changes of output voltage and voltage regulation and over-voltage protection.

Another advantage of exemplary embodiments is that they can be easily integrated as a software routine. Thereby, no altering, or only a minor change of a circuit layout, will be necessary.

Another advantage of certain exemplary embodiments of the invention is that the method is easily integrated in the main voltage regulation loop of the SMPS.

Yet a further advantage of exemplary embodiments is that it is particularly easy to integrate the embodiments in a proportional, integrating, and derivative control loop, PID-control loop, by using the integrating signal to generate the ramp signal.

### BRIEF DESCRIPTION OF THE DRAWINGS

In the following description of embodiments of the invention, reference will be made to the accompanying drawings of which:

FIG. 1 is a schematic block diagram of a synchronous rectifier;

FIG. 2 is a flow diagram of a method according to an embodiment of the invention;

FIG. 3 is a flow diagram of a method according to an exemplary embodiment;

FIG. 4 is a schematic block diagram illustrating a exemplary embodiment of a control unit operatively connected to a synchronous rectifier;

FIG. 5 is a schematic diagram of a control unit according to an exemplary embodiment;

FIG. 6 is a schematic diagram of a pulse generator of a control unit, according to an exemplary embodiment, and

FIG. 7 is a schematic diagram illustrating the embodiment of FIG. 4, further comprising a circuit 701.

### DETAILED DESCRIPTION

The present invention will now be described more fully hereinafter with reference to the accompanying drawings, in which preferred embodiments of the invention are shown. This invention may, however be embodied in many different forms and should not be construed as limited to the embodiments set forth herein; rather, these embodiments are provided so that this disclosure will be thorough and complete, and fully convey the scope of the invention to those skilled in the art. In the drawings, like reference signs refer to like elements.

Moreover, it is apparent that the exemplary methods and devices described below may be implemented, at least partly, by the use of software functioning in conjunction with a programmed microprocessor or general purpose computer, and/or using an application specific integrated circuit (ASIC). Further, while the embodiments of the invention are primarily described in the form of methods and devices, the embodiments may also, at least partly, be implemented as a computer program product or in a system comprising a computer processor and a memory coupled to the processor, wherein the memory is encoded with one or more programs that may perform the functions disclosed herein.

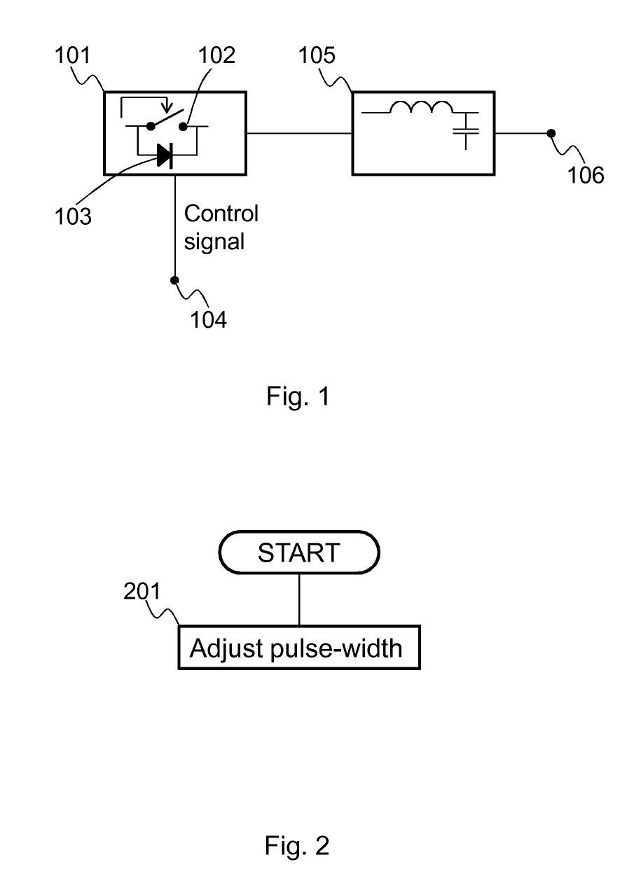

FIG. 1 is a schematic block diagram of a synchronous rectifier 101 operatively connected to a reactive circuit 105. The synchronous rectifier 101 comprises at least one controllable switch 102 controlled by a control signal received at a control terminal 104. At least one controllable switch 102 is operable for supplying the reactive circuit 105 with a voltage. In parallell with the at least one controllable switch 102 is a diode 103 arranged, either on purpose or as a parasitic element of the controllable switch 102. An output voltage is delivered to a load via a voltage terminal 106.

The output voltage at the voltage terminal 106 is controlled by means of adjusting a duty-cycle of the voltage supplied to the reactive circuit 105 from the synchronous rectifier 101. This adjustment of the duty-cycle is normally handled by a voltage regulator arranged to monitor the voltage at the voltage terminal 106. Thus, a defined duty-cycle is derived to achieve the desired output voltage at the voltage terminal 106.

Conventionally, It exists two different ways of operating a synchronous rectifier 101 having at least one controllable switch 102 with a diode arranged in parallell therof, i.e. two different working modes.

The first working mode is the synchronous mode, wherein the at least one controllable switch 102 is operable and controlled by means of the control signal at the control terminal 104. The synchronous mode of operation exhibits low losses but has a high demand on the timing of the control signal. If a pre-bias voltage is present at the voltage terminal 106 a potential risk exists of reversing the power into the synchronous rectifier 101.

The second working mode is the diode mode, wherein the parallell diode 103 of the at least one controllable switch 102 is used as a rectifying diode similar to a conventional SMPS. The diode mode of operation exhibits a voltage drop corresponding to the forward voltage drop of the diode 103. This voltage drop is of the order of 0.5 V and can be a substantial part of the output voltage at the voltage terminal 106. The diode mode of operation also exhibits larger losses compared to the synchronous mode of operation, due to for example a higher series resistance. Hence, the problem of overheating the diodes 103 is not negligable. A beneficial feature of the diode mode is that by nature it is impossible to reverse the power into the synchronous rectifier 101 due to the rectifying properties of the diode 103.

Thus, it would be advantageously for a SMPS with a synchronous rectifier 101 to have a capability to change the working mode between diode mode and synchronous mode of operation in order to supply a voltage against a pre-bias voltage at the voltage terminal 106 without the problems associated with a reversed power floating into the synchronous rectifier 101.

A severe problem associated with changing the working mode of the synchronous rectifier 101 during operation is caused by the forward voltage drop over the diode 103 in the diode mode of operation. If the working mode is changed instantenously between the working modes, a voltage step corresponding to the forward voltage drop of the diode 103 will be present at the voltage terminal 106 as either an increase or a decrease of the output voltage. This voltage step can cause problems with the voltage regulation, and in some cases, when the load connected to the voltage terminal 106 is sensitive to overvoltages, the load can be destroyed or some overvoltage protection measures may be activated, causing the load to malfunction.

However, the reactive circuit 105 in FIG. 1 could be seen as a filter circuit, and not only as an energy reservoir for the SMPS. Hence, a cut-off frequency for the reactive circuit 105 is easy to derive. This cut-off frequency defines a limit for the frequency of the voltage supplied to the reactive circuit 105 from the synchronous rectifier 101. If this cut-off frequency is lower than the switching frequency of the voltage supplied to the reactive circuit 105 from the synchronous rectifier 101, the voltage at the voltage terminal 106 will exhibit small voltage variations caused by the switching frequency of the voltage supplied to the reactive circuit 105 from the synchronous rectifier 101.

Thus, by utilizing the filtering properties of the reactive circuit 105 it is possible to minimize the effect of the forward voltage drop of the diode 103 on the output voltage, associated with operating the synchronous rectifier in the diode mode. This minimization is achieved by adjusting the pulse-width of the control signal.

Based on the above, an exemplary embodiment for a change of working mode from the diode mode to the synchronous mode is described hereinafter, with reference to FIG. 1. When the synchronous rectifier 101 is about to start the operation thereof for supplying a load connected to the voltage terminal 106 with power, the load pre-biases the voltage terminal 106 with a pre-bias voltage. Therefore, the synchronous rectifier 101 may start in diode-mode using only the diode 103 of the at least one controllable switch 102 as rectifying diode for supplying the reactive circuit 105 with voltage pulses that are pulse-width modulated. By increasing the duty-cycle of the control signal from zero percent up to the defined duty-cycle at a frequency above the cut-off frequency of the reactive circuit an increasing amount of voltage pulses caused by activation of the at least one controllable switch 102 reaches the reactive circuit 105. These pulses have slightly higher amplitude compared to the pulses caused by the diode 103, and the difference corresponds to the forward voltage drop of the diode 103. However, the voltage pulses caused by the activation of the at least one controllable switch 102 have a frequency above the cut-off frequency of the reactive circuit 105. Hence, these voltage pulses are filtered by the reactive circuit 105 and the voltage step due to the forward voltage drop of the diode 103 is not transferred to the load at the voltage terminal 106. This effectively causes the synchronous rectifier to change the working mode from the diode mode to the synchronous mode obviating the problems associated with the forward voltage drop of the diode 103.

Hereinbelow is another exemplary embodiment described in connection with FIG. 1 for changing the working mode of a synchronous rectifier 101 from the synchronous mode to the diode mode. In this exemplary embodiment the synchronous rectifier 101 is operating in the synchronous mode for delivering power to a load connected to the voltage terminal 106, and the load will pre-bias the voltage terminal with a voltage upon shutting down the operation of the synchronous rectifier 101. Therefore, to counteract the risk of reversing power into the synchronous rectifier 101, it is desirable to change the working mode from synchronous mode to diode mode upon shutdown. This change of working mode can be performed by decreasing the duty-cycle of the control signal from the defined duty-cycle down to zero percent at a frequency above the cut-off frequency of the reactive circuit. This decrease causes a decreasing amount of voltage pulses caused by activation of the at least one controllable switch 102 to reach the reactive circuit 105. These pulses have slightly lower amplitude compared to the pulses caused by the at least one controllable switch 102, and the difference corresponds to the forward voltage drop of the diode 103. However, the voltage pulses caused by the diode 103 have a frequency above the cut-off frequency of the reactive circuit 105. Hence, these voltage pulses are filtered by the reactive circuit 105 and the voltage step due to the forward voltage drop of the diode 103 is not transferred to the load at the voltage terminal 106. This effectively causes the synchronous rectifier to change the working mode from the synchronous mode to the diode mode obviating the problems associated with the forward voltage drop of the diode 103.

FIG. 2 is a flow diagram of a method according to an embodiment of the invention for changing the working mode of a synchronous rectifier 101 during operation thereof. In this embodiment the synchronous rectifier 101 receives at least one control signal at the control terminal 104 for controlling the at least one controllable switch 102. The at least one control signal is pulse-width modulated with a defined duty-cycle for the desired voltage at the voltage terminal 106. This defined duty-cycle is controlled by an external voltage controller. The change of working mode between diode-mode and synchronous mode, and vice versa, is performed by adjusting 201 the pulse-width of the at least one control signal between zero percent duty-cycle and the defined duty-cycle at a frequency above the cut-off frequency of the reactive circuit 105.

Thus, by performing this adjustment of the pulse-width of the at least one control signal at a frequency above the cut-off frequency of the reactive circuit 105, the voltage step associated with the forward voltage drop of the diode 103 will be filtered and no sharp voltage step will be transferred to the voltage terminal 106.

In another exemplary embodiment, the changing of the working mode of the synchronous rectifier 101 involves changing a diode mode of operation to a synchronous mode operation. This direction of changing a diode mode to a synchronous mode is of great use if a SMPS with a synchronous rectifier 101 that is about to start to operate against a pre-bias voltage at the voltage terminal 106. By starting the synchronous rectifier in diode mode, a very small amount of reverse current will flow into the synchronous rectifier. When the output voltage is at a safe level above the pre-bias voltage, the synchronous rectifier 101 can start the synchronous mode without the risk of reversing power into the synchronous rectifier 101.

In some detail the hereinabove described change of working mode from diode mode to synchronous mode involves increasing the pulse width of the control signal from zero percent to the defined duty-cycle. The zero percent duty-cycle corresponds to a diode mode of operation since the at least one controllable switch 102 is in an off state at zero percent duty cycle and the diode 103 is operable as a rectifying diode. The defined duty-cycle corresponds to the duty-cycle commanded by the external voltage controller for controlling the voltage at the voltage terminal 106. This adjustment of the pulse-width of the at least one control signal is performed at a frequency above the cut-off frequency of the reactive circuit 105.

In an alternative embodiment, the change of the working mode of the synchronous rectifier 101 involves changing a synchronous mode of operation to a diode mode of operation. This direction of changing the working mode from a synchronous mode to a diode mode is of great use if a SMPS having a synchronous rectifier 101 is about to shutdown the operation thereof with a pre-bias voltage present at the voltage terminal 106.

In this embodiment the pulse-width of the at least one control signal is decreased from the defined duty-cycle to zero percent duty-cycle at a frequency above the cut-off frequency of the reactive circuit 105, thereby causing the synchronous rectifier to change the operation thereof from synchronous mode to diode mode.

In a further embodiment, the pulse-width of the at least one control signal is adjusted step-wise over a number of steps at the frequency above the cut-off frequency of the reactive circuit 105.

In a still further embodiment, the number of steps for adjusting the pulse-width of the at least one control signal is in the range of 5 to 20.

In another embodiment, the number of steps for adjusting the pulse-width of the at least one control signal is in the range of 6 to 10.

In a further exemplary embodiment is the hereinabove disclosed method executed a defined time interval after start-up of the synchronous rectifier 101. By starting the synchronous rectifier in diode mode it is assured that no reverse power is flowing into the synchronous rectifier 101.

In an alternative embodiment is the hereinabove disclosed method executed prior to a shutdown of the synchronous rectifier 101.

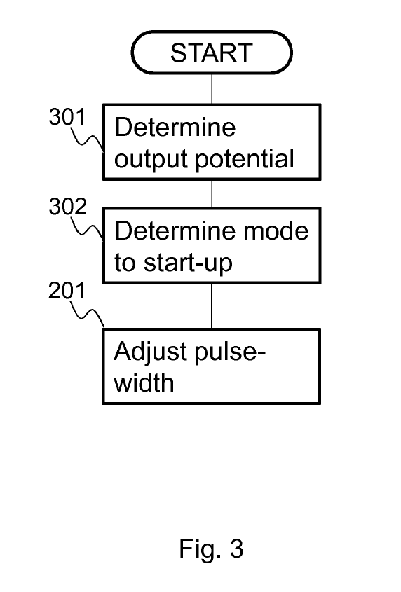

FIG. 3 is a flow diagram illustrating an exemplary embodiment of a method for changing the working mode of a synchronous rectifier. In step 301, an output voltage at the voltage terminal is determined. Based on this determined voltage, the starting mode of the synchronous rectifier is determined, in step 302. If a pre-bias voltage is present at the voltage terminal 106 it may be decided that a diode mode of operation is suitable. Step 302 is followed by the above described step 201 of adjusting the pulse-width of the at least one control signal.

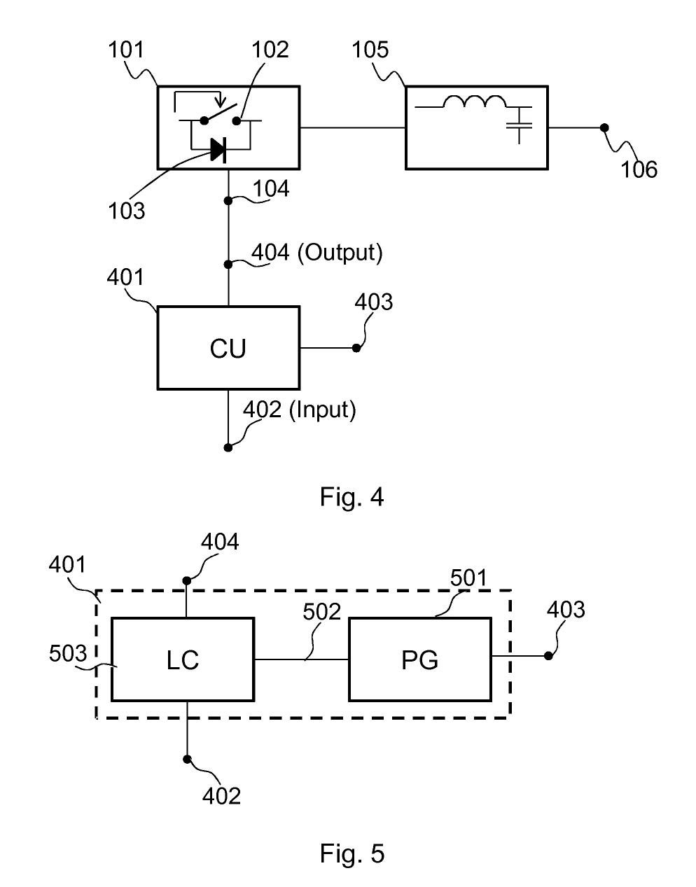

FIG. 4 is a schematic diagram of acontrol unit 401, according to an exemplary embodiment of the invention, wherein the control unit is operatively connected to the synchronous rectifier 101. The control unit 401 comprises at least one input terminal 402 for receiving an input signal. The input signal is pulse-width modulated with a defined duty-cycle for the desired output voltage at the voltage terminal 106. The control unit 401 further comprises an enable terminal 403 for receiving an enable signal. This enable signal initiate the change of working mode for the synronous rectifier. The control unit 401 further comprises at least one output terminal 404 operatively connected to said control terminal 104 for controlling the at least one controllable switch 102 of the synchronous rectifier 101.

The control unit 401 is configured to adjust the pulse-width of the received at least one input signal at the at least one input terminal 402, between zero percent duty-cycle and the defined duty-cycle of the input signal at a frequency above a cut-off frequency of the reactive circuit 105, in response to said enable signal, thereby forming said output signal at the output terminal 404 and reducing the effect of a forward voltage drop over said diodes 103 in the synchronous rectifier 101.

In one exemplary embodiment is the control unit 401 configured to increase the pulse-width of the at least one input signal from zero percent duty-cycle to the defined duty-cycle of the input signal at the frequency above the cut-off frequency of the reactive circuit 105. Thereby, the working mode of the synchronous rectifier 101 is changed from a diode mode of operation to a synchronous mode of operation.

In an alternative exemplary embodiment is the control unit 401 configured to decrease the pulse-width of the at least one input signal from the defined duty-cycle of the input signal to zero percent duty-cycle at the frequency above the cut-off frequency of the reactive circuit 105. Thereby, the working mode of the synchronous rectifier 101 is changed from a synchronous mode of operation to a diode mode of operation.

FIG. 5 is a schematic block diagram illustrating an exemplary embodiment of the control unit 401. The control unit comprises a pulse generator 501 configured to be controllable by said enable signal received at the enable terminal 403, and to generate a pulse train with a gradually changing duty-cycle between zero-percent duty-cycle and the defined duty-cycle of the input signal at a frequency above a cut-off frequency of the reactive circuit 105 at a terminal 502.

The control unit 401 further comprises a logic circuit 503 configured for receiving the pulse train from the pulse generator 501 at the terminal 502. The pulses of the pulse train act as a gate signal for controlling a path from the input terminal 402 to the output terminal 404 of the control unit 401. Thereby, the output signal for controlling the at least one controllable switch 102 of the synchronous rectifier 101 is generated.

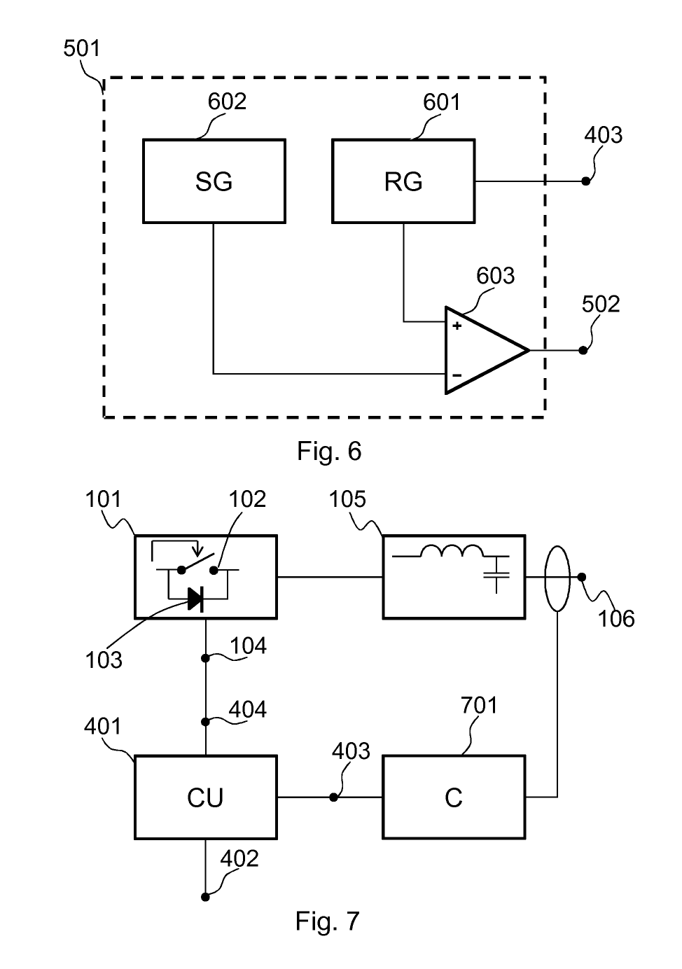

FIG. 6 is a schematic block diagram illustrating an exemplary embodiment of the pulse generator 501 of the control unit 401. The pulse generator 501 comprises a ramp generator 601, which is configured to be controlled by the enable signal received by the enable terminal 403 for starting a linear ramp with a defined ramp time and a defined voltage potential. The defined ramp time gives the available time for changing the working mode of the synchronous rectifer.

The pulse generator 501 further comprises a sawtooth generator 602 configured for generating a sawtooth signal at a defined frequency and a defined amplitude. The frequency of the sawtooth signal is above the cut-off frequency of the reactive circuit 105.

The pulse generator 501 further comprises a comparator 603 with the inputs thereof connected to said ramp generator 601 and to said sawtooth generator 602. The comparator 603 is operative for comparing said linear ramp and said sawtooth signal, forming a pulse train at the output of the comparator operatively connected to the terminal 502. The pulse train acting as a gate signal for the logic circuit 503.

In yet another examplary embodiment is the ramp generator 601 configured for receiving an integrating voltage from a voltage controller configured for regulating the output voltage of the voltage terminal 106 by means of a proportional—integral—derivative controller. Thereby, the control unit 401 is allowed to change the working mode of the synchronous rectifier 101 as a part of the control loop for the voltage at the voltage terminal 106.

FIG. 7 is a schematic block diagram of an examplary embodiment that in addition to the hereinabove disclosed embodiments comprises a circuit 701. This circuit 701 is configured for measuring the output voltage at the voltage terminal 106 and based upon said measurement generate said enable signal at the enable terminal 403 of the control unit 401.

In the drawings and the specification, there have been disclosed typical preferred embodiments of the invention and, although specific terms are employed, they are used in a generic and descriptive sense only and not for purposes of limitation, the scope of the invention being set forth in the following claims.

1. A method for changing a working mode of a synchronous rectifier, the synchronous rectifier comprising at least one controllable switch having a diode in parallell thereof, the synchronous rectifier being operatively connected to a reactive circuit and is arranged to receive at least one control signal at a control terminal, for controlling said at least one controllable switch, wherein the at least one control signal is pulse-width modulated with a defined duty-cycle, the method comprising:
adjusting the pulse-width of the at least one control signal between zero percent duty-cycle and the defined duty-cycle at a frequency above a cut-off frequency of the reactive circuit, thereby reducing the effect of a forward voltage drop over said diode in the synchronous rectifier.

2. The method according to claim 1, wherein the working mode of the synchronous rectifier is changed from a diode mode of operation to a synchronous mode of operation, by the adjusting of the pulse-width comprising:
increasing the pulse-width of the at least one control signal from zero percent duty-cycle to the defined duty-cycle at the frequency above the cut-off frequency of the reactive circuit.

3. The method according to claim 1, wherein the working mode of the synchronous rectifier is changed from a synchronous mode of operation to a diode mode of operation, by the adjusting of the pulse-width comprising :
decreasing the pulse-width of the at least one control signal from the defined duty-cycle to zero percent duty-cycle at the frequency above the cut-off frequency of the reactive circuit

4. The method according to claim 1, wherein said pulse-width of the at least one control signal is adjusted step-wise over a number of steps at said frequency above the cut-off frequency of the reactive circuit.

5. The method according to claim 4, wherein the number of steps is in the range of 5 to 20.

6. The method according to claim 5, wherein the number of steps is in the range of 6 to 10.

7. The method according to claim 1, wherein the method is executed a defined time interval after start-up of the synchronous rectifier.

8. The method according to claim 1, wherein the method is executed prior to a shutdown of the synchronous rectifier.

9. The method according to claim 1, wherein a circuit is configured for determining an output potential of a voltage terminal, wherein a start-up of the synchronous rectifier is preceded by:
determining an output potential of the voltage terminal; and
determining a start-up mode for the synchronous rectifier, based on the determination of the output potential.

10. A control unit for changing a working mode of a synchronous rectifier, the synchronous rectifier comprising:
at least one controllable switch having a diode in parallell thereof, wherein said at least one controllable switch is controlled by at least one control signal received at a control terminal, the synchronous rectifier being operatively connected to a reactive circuit, and the control unit comprising:
at least one input terminal for receiving an input signal, wherein the input signal is pulse-width modulated with a defined duty-cycle, for controlling the at least one controllable switch of the synchronous rectifier;
an enable terminal for receiving an enable signal; and
at least one output terminal operatively connected to said control terminal,
wherein the control unit is configured to adjust the pulse-width of the received at least one input signal at the at least one input terminal, between zero percent duty-cycle and the defined duty-cycle of the input signal at a frequency above a cut-off frequency of the reactive circuit, in response to said enable signal, thereby forming said output signal at the output terminal and reducing the effect of a forward voltage drop over said diodes in the synchronous rectifier.

11. The control unit according to claim 10, further configured to:
increase the pulse-width of the at least one input signal from zero percent duty-cycle to the defined duty-cycle of the input signal at the frequency above the cut-off frequency of the reactive circuit, thereby changing the working mode of the synchronous rectifier from a diode mode of operation to a synchronous mode of operation.

12. The control unit according to claim 10, further configured to:
decrease the pulse-width of the at least one input signal from the defined duty-cycle of the input signal to zero percent duty-cycle at the frequency above the cut-off frequency of the reactive circuit, thereby changing the working mode of the synchronous rectifier from a synchronous mode of operation to a diode mode of operation.

13. The control unit according to claim 10, further comprising:
a pulse generator configured to be controlled by said enable signal and to generate a pulse train with a gradually changing duty-cycle between zero-percent duty-cycle and the defined duty-cycle of the input signal at a frequency above a cut-off frequency of the reactive circuit,
a logic circuit configured for receiving the pulse train from the pulse generator, wherein the pulses of the pulse train act as a gate signal for controlling a path from the input terminal to the output terminal of the control unit, thereby generating the output signal for controlling the at least one controllable switch of the synchronous rectifier,

14. The control unit according to claim 13, wherein the pulse generator comprises:
a ramp generator configured to be controlled by the enable signal received by the enable terminal for starting a linear ramp with a defined ramp time and a defined voltage potential,
a sawtooth generator configured for generating a sawtooth signal at a defined frequency and a defined amplitude,
a comparator with the inputs thereof connected to said ramp generator and to said sawtooth generator and operative for comparing said linear ramp and said sawtooth signal, wherein the output of the comparator forms said pulse train acting as a gate signal for the logic circuit.

15. The control unit according to claim 14, wherein the ramp generator is configured for receiving a integrating voltage from a voltage controller configured for regulating the output voltage of the voltage terminal by means of a proportional—integral—derivative controller, thereby allowing the control-unit to change the working mode of the synchronous rectifier as a part of the control loop.

16. The control unit according to claim 10, wherein the control unit is operatively connected to a circuit configured for measuring the output potential of the voltage terminal and based up on said measurement generate said enable signal.
